(19) United States
(12) Patent Application Publication
(10) Pub. No.: US 2015/0150218 A1
(43) Pub. Date: Jun. 4, 2015

(54) SYSTEMS AND METHODS FOR PRIMP SLICKERS

(71) Applicant: Loretta Buckley, Buckeye, AZ (US)

(72) Inventor: Loretta Buckley, Buckeye, AZ (US)

(21) Appl. No.: 14/339,379

(22) Filed: Jul. 23, 2014

Related U.S. Application Data
(60) Provisional application No. 61/858,022, filed on Jul. 24, 2013.

(51) Int. Cl. A01K 13/00; B68C 1/12

(52) U.S. Cl. CPC A01K 13/007; B68C 1/12

(57) ABSTRACT

Systems and methods are directed to a decorative and practical line of horse accessories. A line of cloth coverings is disclosed that are produced from a flexible, elastic fabric such as nylon or lycra. The set may include a covering for the horse's saddle pad and four coverings for the splint boots. The saddle pad covering stretches over the existing saddle pad. The boot coverings fit like a sock, just covering the boot and not putting any pressure on the horse's skin. Once in place, these coverings protect the splint boots and saddle pad from stains and contaminates. The coverings can be easily removed and washed as needed. In addition to their functional use, the “PRIMP SLICKERS” can be produced in a variety of decorative patterns to add style to the horse's appearance.

### CROSS-REFERENCE TO RELATED APPLICATIONS

This application claims priority to U.S. patent application Ser. No. 61/858,022, filed Jul. 24, 2013, the disclosure of which is incorporated by reference in its entirety for all purposes.

### BACKGROUND

Horseback riding is a wonderful activity that is enjoyed by many. Whether it be an experienced rider entering a competition at a fair, a hired hand working on a farm or range, or an urban resident traveling to the country for an afternoon of riding, there is something exhilarating about riding high in the saddle and controlling an animal as beautiful as a horse.

The horse industry is extremely popular for a variety of reasons. For example, many city-dwellers are turning to the country as a place for rest and relaxation. Whether it is for a weekend, week, month, or lifetime, Americans are finding that the country is a wonderful place to relax and unwind. The horse industry has also expanded to many Americans who may have never had a chance to enjoy such an activity. For example, there are riding schools, schools to teach young children, and dude ranches for adults. There are also special riding trails and trained guides who are trained to help blind riders and individuals with handicaps and physical limitations.

In addition, many horse owners enjoy showing their pets at shows, fairs, and competitions in which the horses may be ridden or driven or guided by handlers on foot. The purpose of a horse show is to display purebred horses to breeders and exhibitors and to entertain the interested public. Show horses are broadly designated as either breeding-class or performance animals. A breeding-class horse is judged largely on its appearance and movements while being led by a dismounted handler; whereas, a performance-class horse is rated largely on its ability to perform such tasks as drawing a guided vehicle or jumping over obstacles while carrying a rider. Performance-class events simulate conditions encountered in hunting, working cattle, and other pursuits. Horses that compete in major shows are assigned to one of several main divisions into which the events of the show are grouped, including hunter, jumper, saddle horse, harness, Western (or stock) horse, equitation, dressage, and driving. For example, in the equitation division, the rider, not the mount, is judged; in dressage, the ability of the horse to execute certain intricate movements is judged. In some events of the hunter-and-jumper category, the entries are required to leap across obstacles such as a high wooden rail flanked on either side by two lower rails; and in the harness division, horses and ponies with high-stepping gaits pull two-wheeled carts. These divisions are often further subdivided into classes based on age, size, and ability. The criteria by which show judges rate horses include conformation (height, weight, and form of the animal); quality, or degree of refinement in build; substance, or soundness of bone and muscle; condition, or health, training, and fitness; and temperament.

Considering the magnitude of horse shows, it is easy to imagine the importance of quality equipment and proper care and conditioning of these beautiful animals. There are many products designed to ease the process of mounting, riding, and caring for a horse. There are also many products that provide comfort and support for the horse as well as ease the process of preparation and overall care.

Horse saddle pads or horse saddle blankets are pads or fabrics inserted under a saddle. These are usually used to absorb sweat and protect the horse's back. As such, the saddle pads can become stained and discolored. Similarly, splint boots are used to protect a horse's legs, especially the lower leg from injury. The splint boots can become stained and discolored after use.

A horse accessory is needed that can protect the saddle pad and splint boots from becoming stained and discolored. In addition, as the saddle pad and splint boots are very functional in nature, they are made from a fabric that is monotone in color and not particularly decorative. Thus, a horse accessory is needed that is also decorative and easy to clean that can be used to protect the saddle pad and splint boots.

### BRIEF DESCRIPTION OF EXEMPLARY DRAWINGS

A more complete understanding of the various embodiments may be derived by referring to the detailed description and claims when considered in connection with the following illustrative figures:

FIGS. 1-5 illustrate exemplary embodiments of the “primp slickers” covering the saddle pad and the splint boots of a horse;

FIG. 6 illustrates exemplary embodiments of methods for making the saddle pad covering and boot coverings of the “primp slickers”;

FIG. 7 illustrates an exemplary embodiment of a method for making the boot coverings of the “primp slickers”; and FIGS. 8A-8B illustrate an exemplary embodiment of a method for making the saddle pad covering of the “primp slickers.”

### DETAILED DESCRIPTION OF EXEMPLARY EMBODIMENTS

The concept of “PRIMP SLICKERS” is a decorative and practical line of horse accessories. Various embodiments are disclosed for a line of cloth coverings produced from a flexible, elastic fabric such as nylon or lycra. The set may include a covering for the horse's saddle pad and four coverings for the splint boots. The saddle pad covering would simply stretch over the existing saddle pad. The boot coverings fit like a sock, just covering the boot and not putting any pressure on the horse's skin. Once in place, these coverings protect the splint boots and saddle pad from stains and contaminates. The coverings can be easily removed and washed as needed. In addition to their functional use, the “PRIMP SLICKERS” can be produced in a variety of decorative patterns to add style to the horse's appearance.

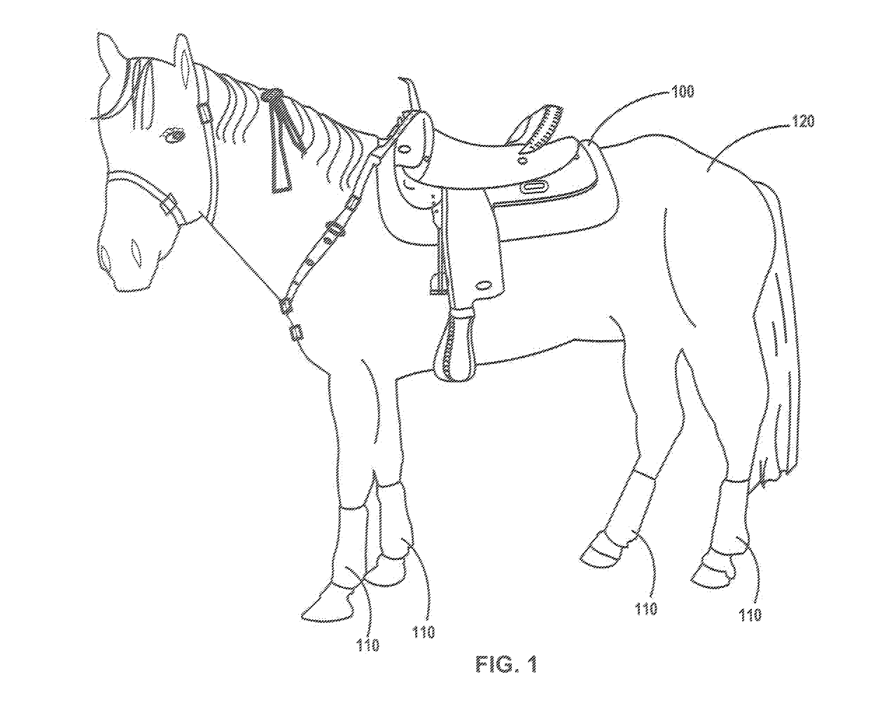

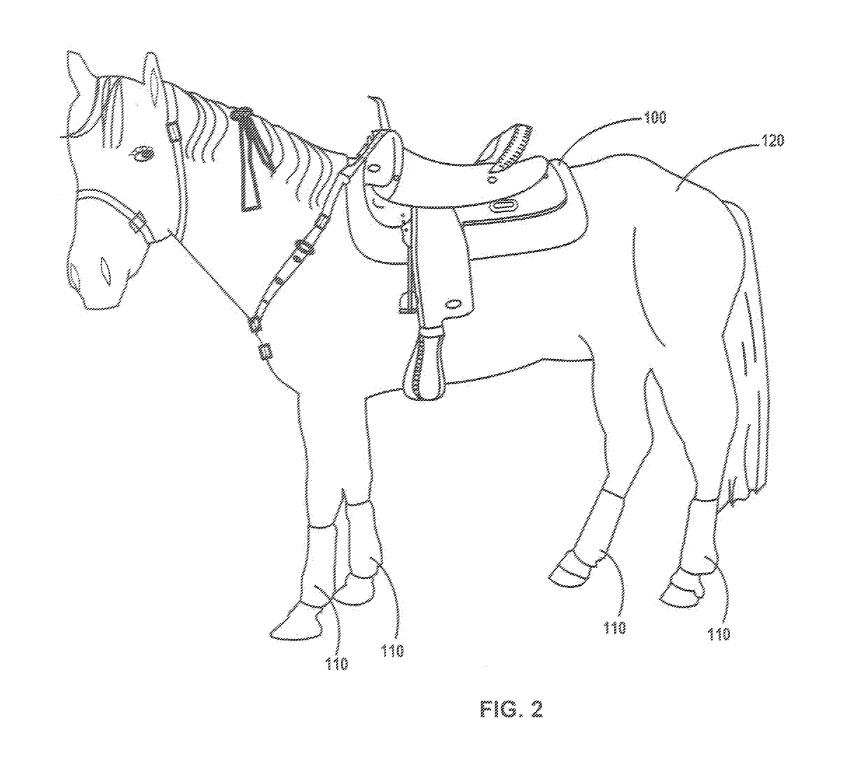

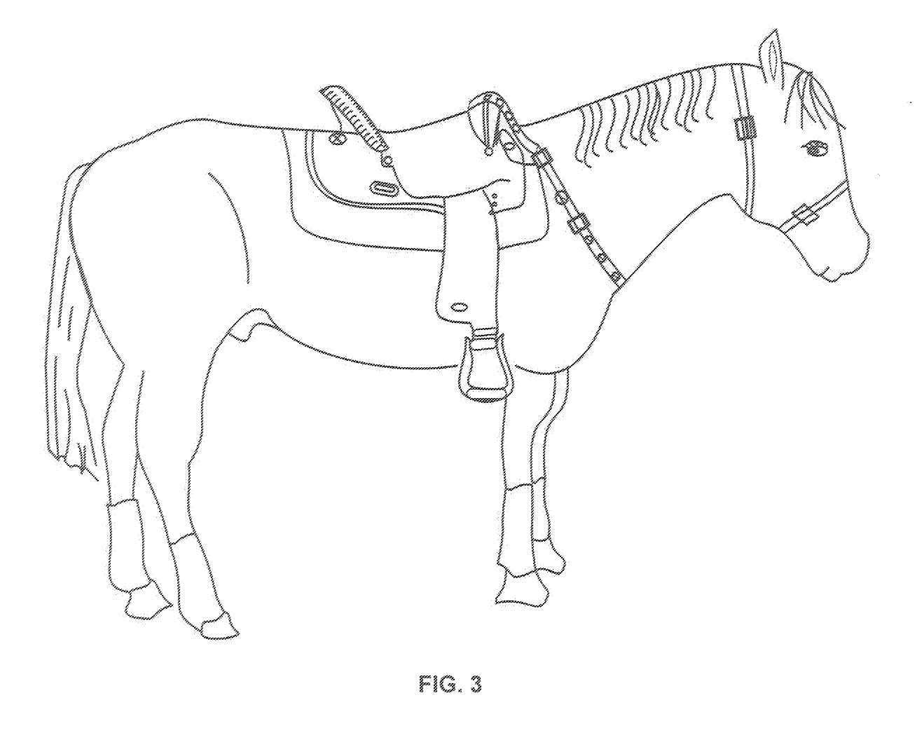

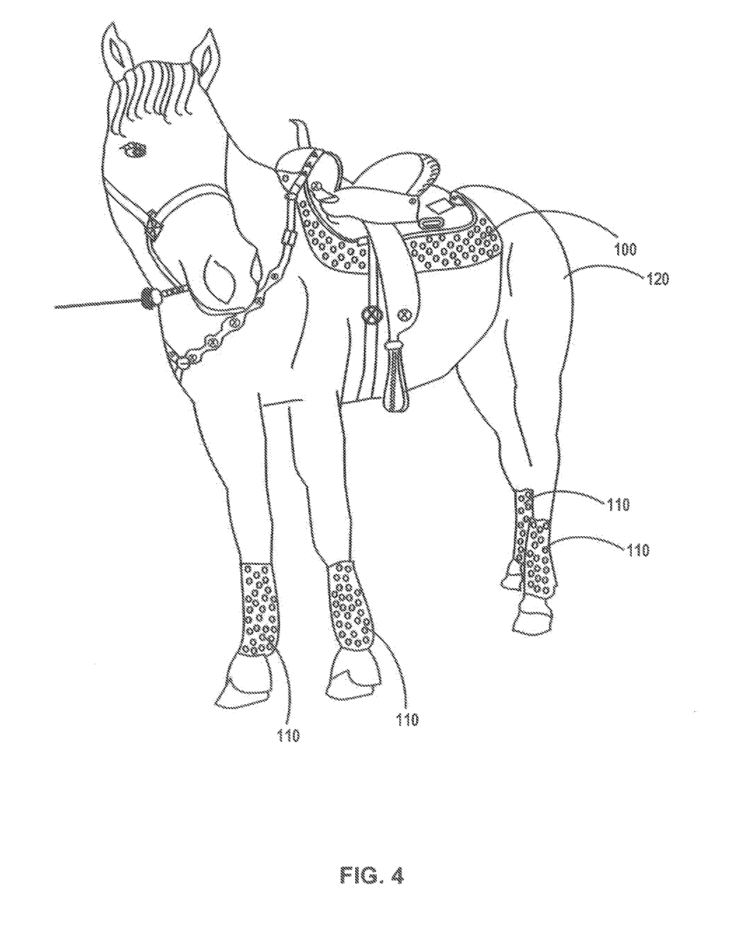

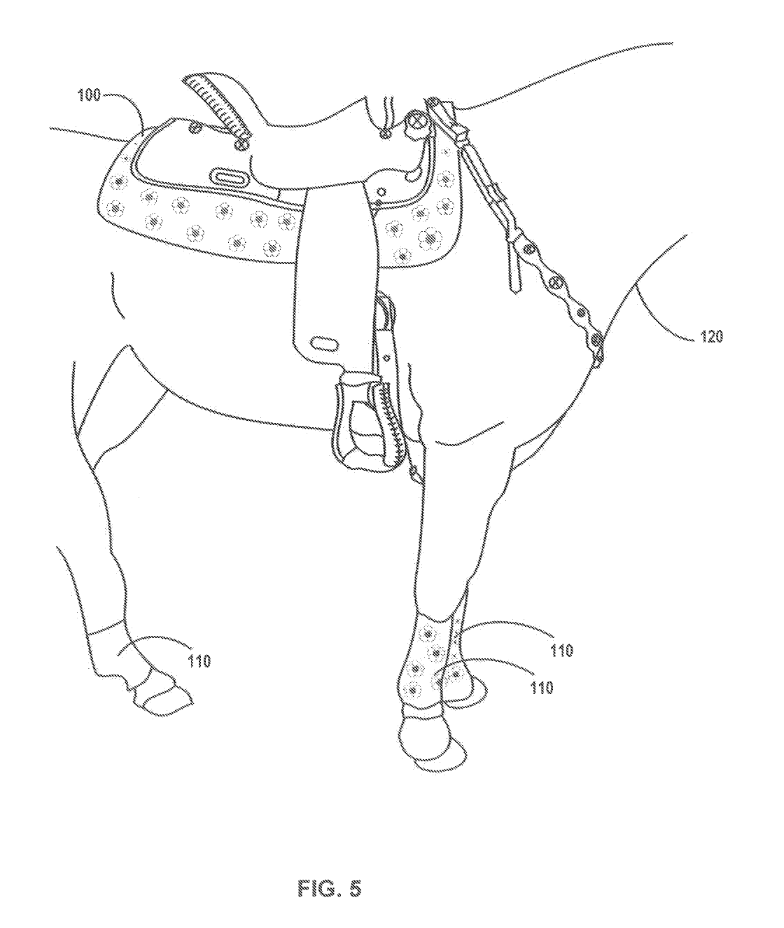

With reference to FIGS. 1-5, “Primp Slickers” 100, 110 are illustrated as used to cover the saddle pad and splint boots of a horse 120. Accessory 100 covers the saddle pad of the horse. Accessory 100 stretches over the top surface of the saddle pad and just goes over the edges of the saddle pad, but accessory 100 does not go completely around the saddle pad. This ensures that there is no slipping of the saddle pad when placed on the horse. Similarly, accessories 110 stretch over the outside surface of the splint boots and just over the edges of the splint boots, but accessories 110 do not go completely around the splint boots. Accessories 100, 110 are made of a flexible, elastic fabric that enable the accessories to fit over the saddle pad and splint boots without putting any pressure on the horse's skin.

The “PRIMP SLICKERS” fulfill the need for a unique and decorative line of fabric coverings for use on horses. One of the appealing features of “PRIMP SLICKERS” is their practicality, convenience, stylish appearance, and ease of use. The “PRIMP SLICKERS” give a horse or livestock owner peace of mind that the saddle pad and splint boots on the horse are clean and comfortable. They can be easily removed for laundering and reduce the frequency that the pad and boots themselves have to be cleaned. In addition, these decorative coverings provide a unique and fashionable appearance for the horse and rider. The rider can select a favorite from a wide variety of colors and patterns. The “PRIMP SLICKERS” are inexpensive, as well as durable for years of effective use. They appeal to any owner of one or more horses.

There exists various options for the production of “PRIMP SLICKERS” in ways which that make them more appealing to a wider range of end users. This includes producing the units in a variety of decorative patterns and colors, as well as in sizes to fit any saddle pad and splint boots.

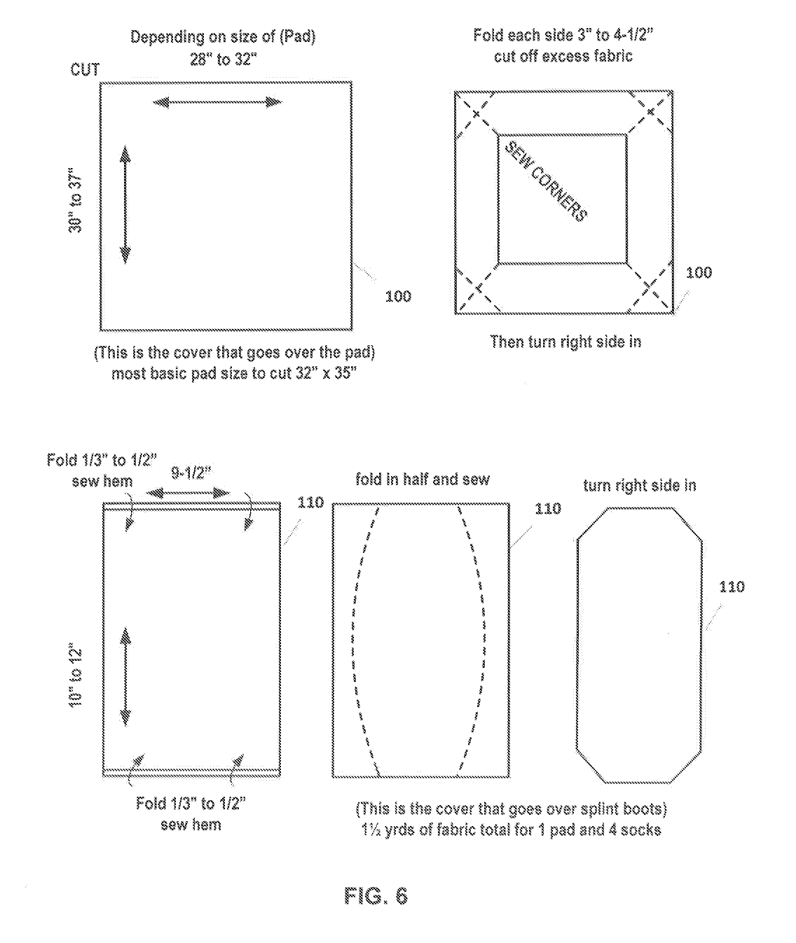

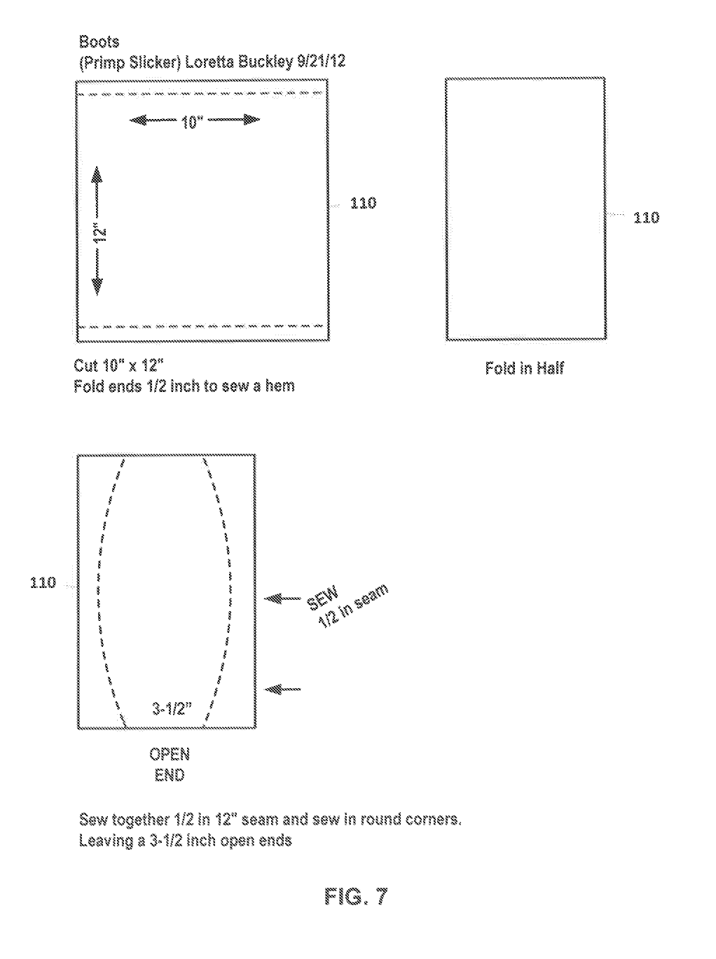

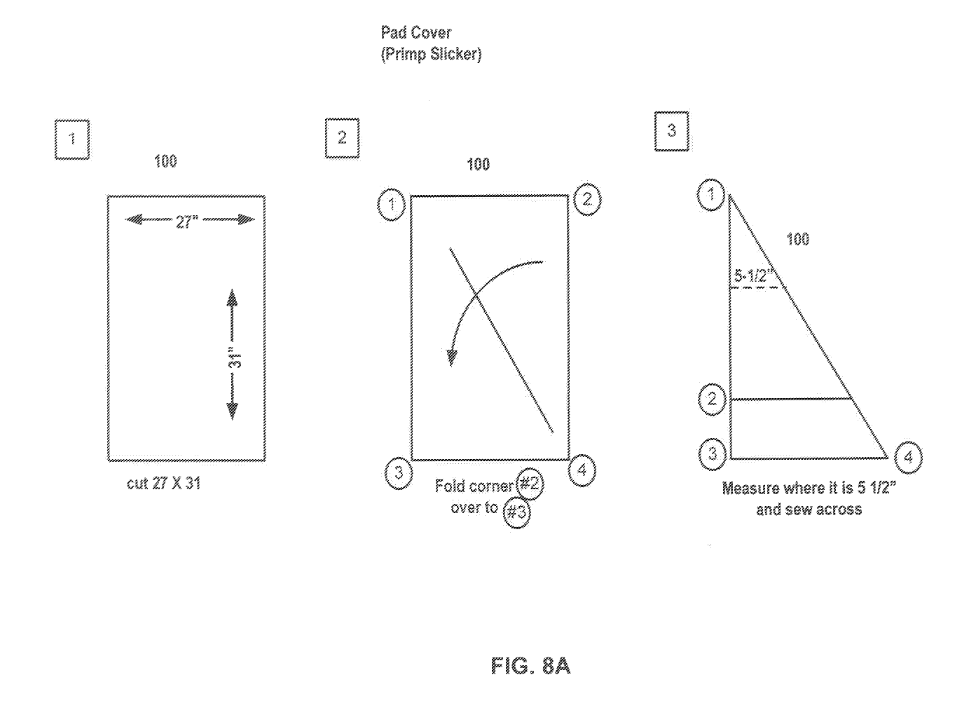

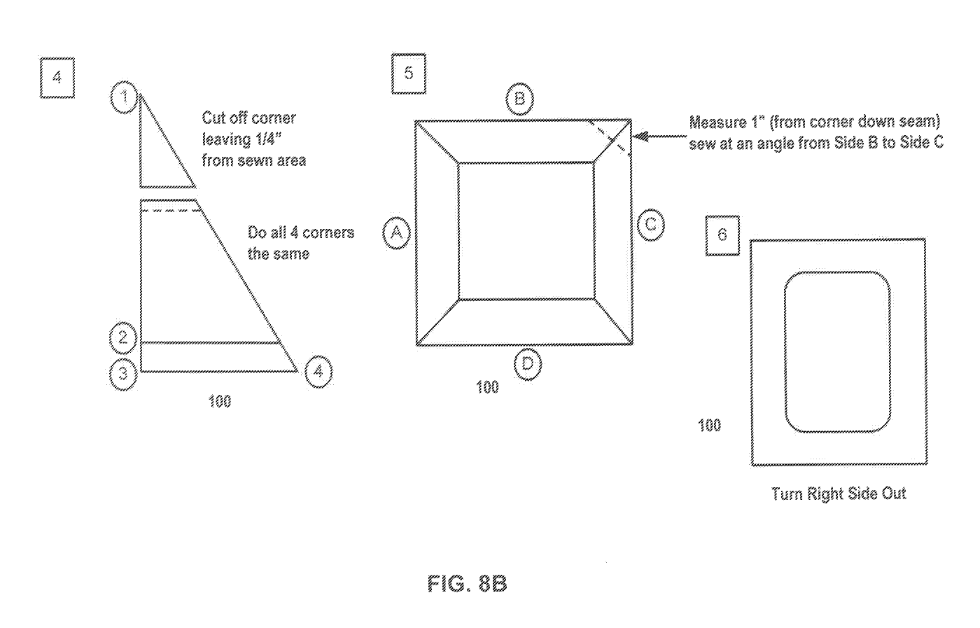

With reference to FIGS. 6-7 and 8A-8B, accessories 100, 110 (or “PRIMP SLICKERS”) can be produced easily using conventional and readily available materials and manufacturing processes. No new production technology is required.

“PRIMP SLICKERS” can be produced in a manner similar to other wearing apparel and incorporate comparable mass production procedures. Basic materials that could be used include nylon or lycra. With reference to

A computer can be used to produce a pattern for the components of the garment in the desired sizes and possibly to create an optimal layout to minimize waste. Production workers can use an electric knife or other cutting tool to cut the pattern pieces from multiple layers of fabric or use a computer-controlled machine to do the cutting. Sewers would then assemble the pieces of the garment by seaming or serging, and the finishing of the garment would include the placement of elastic edging by machine stitching. The finished garment could be inspected, any lint or stray threads removed, and the product packaged.

“PRIMP SLICKERS” may be packaged in a polyvinylchloride plastic pouch, heat sealed to protect the contents, with the top then being fitted with an imprinted cardboard pressboard header panel (imprinted with product identification and instructions for use). The header panel could be punched with a single hole for rack merchandising.

The “PRIMP SLICKERS” have been designed as a line of protective covers for use by horses. Each set would include a saddle pad cover and a set of four splint boot covers. Each cover would be produced from smooth nylon or lycra with elastic edging to hold it in place. Once in place, the covers would serve to protect the saddle pad and splint boots as well as increase the comfort level of the horse. They could be easily removed for laundering and would reduce the need to clean the pad and boots as frequently.

In addition to their protective uses, the “PRIMP SLICKERS” can be decorative and stylish. They can be offered in a wide variety of colors and patterns, thus allowing the rider to select a unit that he or she prefers. They add a decorative appearance to horse and rider. The “PRIMP SLICKERS” could appeal to any owner of one or more horses. They could also be used by farmers and other commercial owners of livestock.

In regard to the “PRIMP SLICKERS”, it is of interest to examine the recent performance of the horse industry. The horse industry is highly diverse and supports a wide variety of activities in all regions of the country. It combines the primarily rural activities of breeding, training, maintaining, and riding horses with the more urban activities of operating racetracks, horse shows, and public sales.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A system for protecting a saddle pad and splint boots of a horse, the system comprising:
a first accessory comprising a flexible, elastic fabric, wherein the first accessory is configured to cover a top surface of the saddle pad; and
a second accessory comprising a flexible, elastic fabric, wherein the second accessory is configured to cover an outer surface of one of the splint boots.

2. The system of claim 1, wherein the first accessory is further configured to cover each of the edges of the saddle pad without extending around a bottom surface of the saddle pad.

3. The system of claim 1, wherein the second accessory is further configured to cover each of the edges of the splint boots without extending around an inner surface of the splint boots.

4. The system of claim 1, wherein the first and second accessory is comprised of nylon.

5. The system of claim 1, wherein the first and second accessory is comprised of lycra.
